(19) United States
(12) Patent Application Publication
(10) Pub. No.: US 2002/0116175 A1
(43) Pub. Date: Aug. 22, 2002

(54) Method and system for using a voice channel with a data service

(76) Inventors: Scott Allen Stouffer, San Bruno, CA (US); Geoffrey Hendrey, San Bruno, CA (US)

Correspondence Address: BANNER & WITCOFF, 1001 G STREET N W, SUITE 1100, WASHINGTON, DC, 20001, US

(21) Appl. No.: 09/784,096

(22) Filed: Feb. 16, 2001

Related U.S. Application Data
(60) Provisional application No. 60/256,091, filed on Dec. 15, 2000.

(51) Int. Cl. G06F 17/27

(52) U.S. Cl. 704/9

(57) ABSTRACT

A method and system for using a voice channel in a mobile telecommunications system is disclosed. The voice channel is used to generate data based on one or more verbal communications provided by a user of the voice of a user of the mobile unit. The data generated using the voice channel is output to a data service using the data channel. The data generated may be location information corresponding to a location spoken by the user. The location may be determined by successively drilling down a hierarchy of location sets using a context-sensitive dictionary or grammar file of location features. The data generated may also be authentication information. The identity of a user may be confirmed by comparing the user's voice to preexisting voice data corresponding to an individual. The determined location or authentication results are passed as input to the data service.

This application claims priority to U.S. Provisional Patent Application Ser. No. 60/256,091, filed on Dec. 15, 2000.

### BACKGROUND OF THE INVENTION

The present invention relates generally to telecommunications. More particularly, the invention relates to a method and system for obtaining information from a voice channel while using a data service in a mobile telecommunications environment.

A mobile telecommunications system, as referred to herein, is a known telecommunications topography wherein there are mobile units (MU) and base units (BU) that wirelessly communicate in order to provide telecommunications services. Known mobile telecommunications systems make use of both voice channels and data channels. That is, a MU uses a voice channel when a user makes a traditional telephone call. Regardless of whether the user is calling another MU or a traditional “wired” telephone, the MU uses a voice channel to communicate with the nearest BU. The BU then further routes the call to the correct location. A MU may use a data channel for more recently developed applications, such as wireless web access, paging services, caller ID, and the like. In each instance, the MU either uses a data channel or a voice channel, but typically not both simultaneously.

When a user is actively using a data service over a data channel on his or her MU, the data service may use the physical location (e.g., latitude and longitude) of the MU to provide location-based information. For example, a data service may suggest a nearby restaurant or hotel. However, if users do not know their latitude and longitude information, they cannot make full use of the location-based service (LBS).

Known location determination technologies include Global Positioning Systems (“GPS”) and network based methods. GPS based methods use signals generated from 24 satellites orbiting the earth to determine the position of a MU, accurate to a few meters. A significant disadvantage of GPS solutions is that they require that the mobile device being located to be equipped with GPS hardware.

Known network based methods, e.g., time difference of arrival (TDOA), angle of arrival (AOA), and location pattern matching systems, are an alternative to GPS. These methods generally involve triangulating the radio emission of the mobile unit or using RF multipath “fingerprinting” to identify the most likely position of the radiating source. There are believed to be performance advantages to the multipath method over triangulation. In urban environments, an accuracy of 30 meters has been achieved. While less accurate than GPS, network based methods work readily on existing phones.

However, these known location determining platforms are dependent on the deployment of either new end-user equipment (in GPS based systems), or Mobile Locating Centers (MLC, in network based systems). MLCs are the data centers required to provide triangulation services and RF multipath fingerprinting, or other location services external to the mobile unit. While MLCs are being deployed to make locating a MU more practical, network operators are not presently required to have such locating infrastructure in place.

Also, as wireless applications begin to provide a wide array of data services to mobile users, there has arisen a need to authenticate a user before providing selective data services. Some of these services allow the user to view or manipulate private and/or financial information. For instance, a wireless application might allow a user to trade stocks, receive bank account information, or even transfer funds from one account to another, using a mobile unit. In such instances, service providers want to ensure that the owner of the funds/account is actually the individual that is making the request, and not someone else who happened to find the mobile unit from which the request is being made.

Known ways of authenticating a user include using a password or personal identification number (PIN), collectively referred to herein as passcodes. Passcodes, however, may be forgotten. Often, users write them down so as not to forget them. When they are written down, passcodes may be easily copied or stolen if found. Also, passcodes are often deduced from known information regarding an individual. For instance, a common passcode is to use a child's name or birthday. If a thief knows this information regarding a user, the thief may more easily determine what the user's passcode may be. A better way of performing authentication that is not susceptible to loss or theft is therefore needed.

### SUMMARY OF THE INVENTION

In one aspect, the invention is embodied in a method for obtaining data from a voice channel. An application using a data channel is initiated. A user speaks over a voice channel. The voice communications are converted into application data. The application data is provided to the application.

In another embodiment, the invention provides a location of a mobile unit. A first data file corresponding to a first set of localities is loaded. The user's voice is compared to the first data file to determine a first selected locality. A second data file corresponding to a second set of localities is loaded. The second set of localities are geographically located within the selected locality. These steps are repeated until a precise location is determined.

In some embodiments, a locality may be a landmark.

In another aspect, the invention is embodied in a system for providing voice channel services in a telecommunications network. There is a processor and a memory containing computer readable instructions that cause the system to perform a set of steps. The system initiates an application using a data channel. The system receives voice input spoken by a user over a voice channel. The system converts the voice communication to application data, and provides the application data to the application.

In another aspect, the invention is embodied in a system for refining the location of a mobile unit. There is a processor and a memory containing computer readable instructions that cause the system to perform a set of steps. The system loads a first data file corresponding to a first set of localities. The system receives a first voice input from a user and compares it to the first data file to determine a first selected locality. The system loads a second data file corresponding to a second set of localities. Each of the localities in the second set are geographically located at least partially within the selected locality. These steps are repeated until a location is determined.

### BRIEF DESCRIPTION OF DRAWINGS

FIG. 1A shows a mobile telecommunications system in accordance with the invention.

FIG. 1B shows a server configured according to an embodiment of the invention.

FIG. 2A shows a timeline of data channel and voice channel use according to an embodiment of the invention.

FIG. 2B shows a data flow diagram for an embodiment of the invention.

FIG. 2C shows a flowchart for an aspect of the invention.

FIG. 3 shows a flowchart of a method for determining a location in accordance with the invention.

FIG. 4 shows a geographic representation of an embodiment of the invention.

FIG. 5 shows a flowchart of a method for performing voice authentication in accordance with the invention.

### DETAILED DESCRIPTION OF PREFERRED EMBODIMENTS

The present invention provides a method and system for accepting input from a voice channel for use by a data service, in a mobile telecommunications environment. Using the present invention, in a mobile telecommunications environment data may be input through a voice channel and passed to a data service that makes use of a data channel, while the data channel remains assigned to a mobile unit.

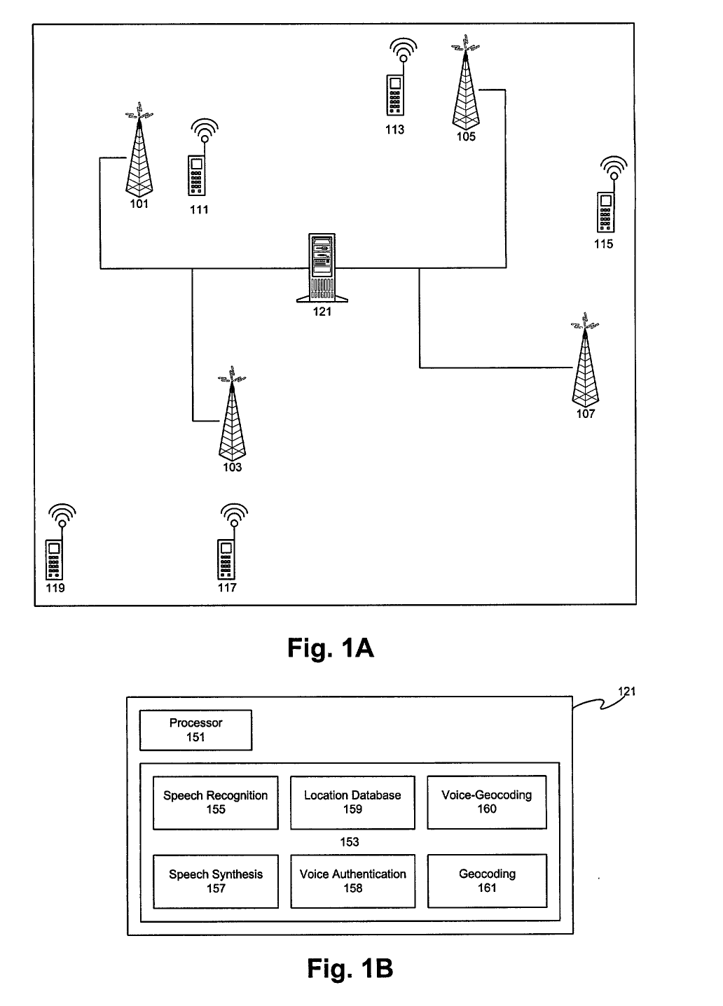

With reference to FIG. 1A, in a mobile telecommunications environment adapted to perform location-based services, there are one or more communications antennas (base units) 101-107, mobile units (MU) 111-119, and a voice services server 121. Mobile units 111-119 communicate wirelessly with communications antennas 101-107 using known means. Each antenna communicates with, either directly or indirectly, voice services server 121. The voice services server is adapted to perform certain steps as described below. It should be apparent that the network topology shown in FIG. 1 is an example of a network topology that may be used, and is not meant as a limitation. More than one voice services server may be used. For instance, one server may be used per voice application, or all voice applications may reside on one or more servers, depending on network usage and capacity.

With reference to FIG. 1B, the server 121 is shown in greater detail, as it is used in one embodiment of the invention. There is a processor 151 and a memory 153. In the memory is stored speech recognition software 155, speech synthesis software 157, voice authentication software 158, location information 159 including grammar files (discussed below), voice-geocoder 160, and geocoder 161.

Using the above or similar topology, the present invention may provide a mobile unit's location using voice-geocoding. Geocoding, generally, refers to the process of assigning X and Y coordinates to a location for purposes of plotting the location on a map. In the present invention, a voice-geocoding software module uses speech-to-text technology to convert spoken location information to computer readable data. The geocoder software module compares the computer readable data to a data library of location information and returns specific location information, such as latitude and longitude coordinates. The latitude and longitude coordinates may then be used in location-based services. A voice channel using the present invention may also provide user authentication while a user is utilizing a data service.

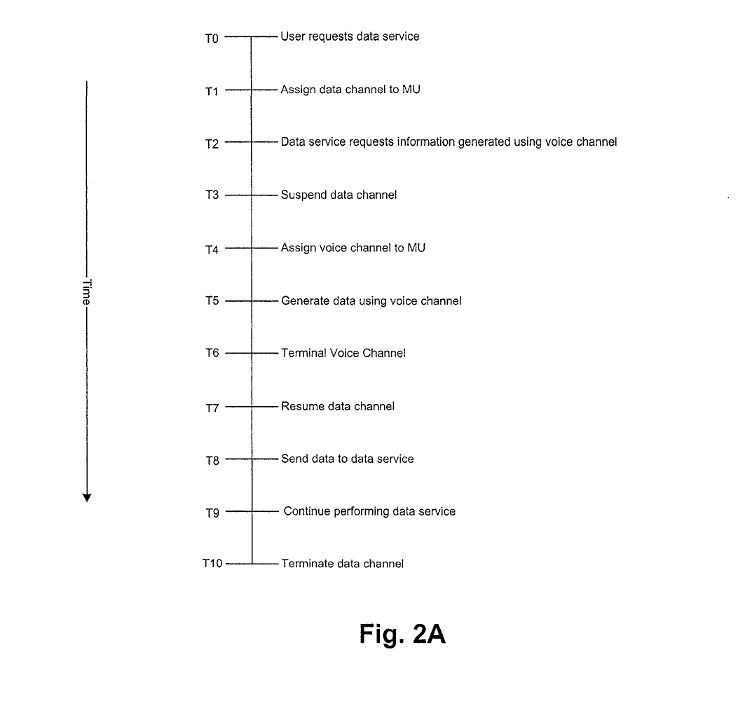

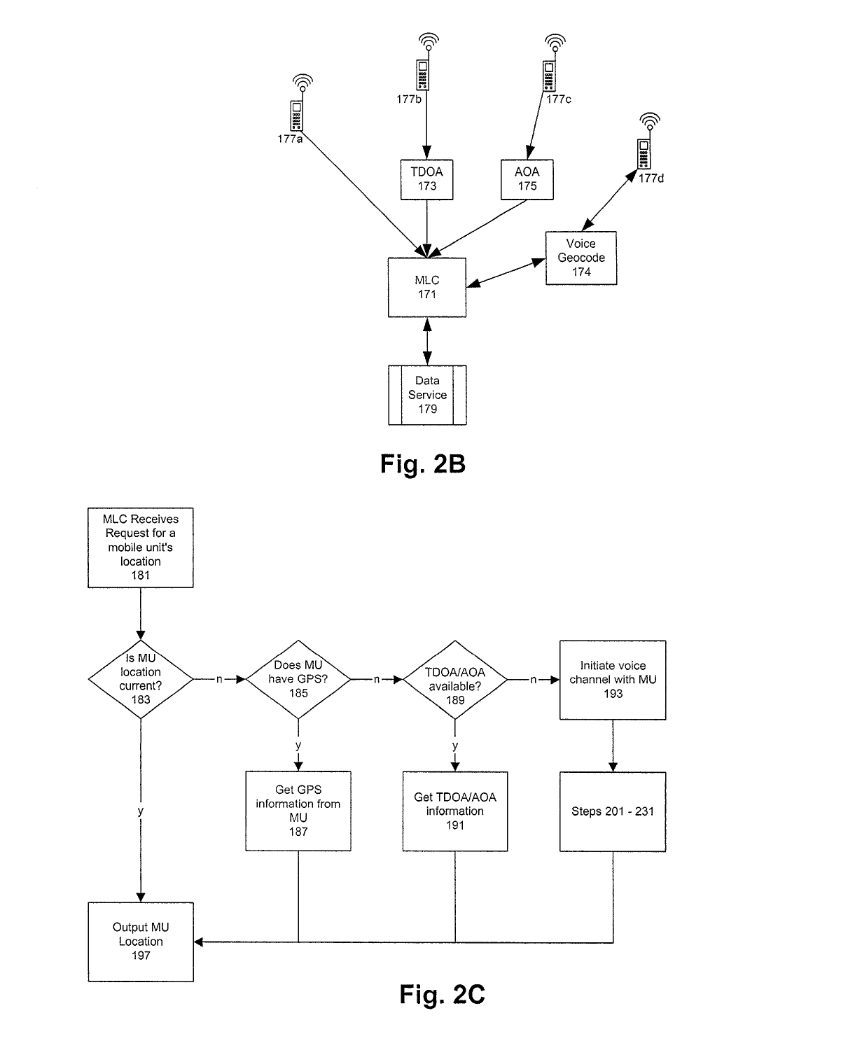

With reference to FIG. 2A, at a time T0 a user requests a data channel service via a MU. A data service may be a wireless web application such as the provisioning of stock quotes, movie showtimes, or the like, direct messaging services such as AT&T's 2-Way Text Messaging service, or other non-voice related services.

At a time T1, in response to the user's request for a data service, the telecommunications system assigns and opens a data channel with the user's MU, allowing the data service to commence. At some point T2 during the data service, the data service requests input that, if not otherwise available to the data service, may be generated by the user's voice over a voice channel. In response to the request, the system temporarily suspends the data channel at time T3, but the system does not relinquish the data channel such that it could be assigned to another MU. Optionally, provided the MU has the necessary hardware to maintain two open channels, the data channel may remain active while the voice channel is in use.

After the system suspends the data channel, the system assigns and establishes a voice channel with the MU at time T4. The user interacts with an entity via voice using the voice channel, generating data at time T5. The entity that the user interacts with may be any type of entity that can generate data for use with a data service. For instance, if the data service is a travel information service via a wireless web application, the entity may be a person such as a reservations operator for an airline or car rental agency. The operator may make a reservation for the user and send the reservation information to the data service. The data service may then continue to provide additional information to the user based on the reservation information, such as informing the user of special events at the travel location during the user's period of travel.

The entity may also be a computer system enabled with speech recognition technology. For instance, where the data service is a location-based service (LBS), and the system or MU is not equipped to autonomously provide the MU location (such as using GPS or triangulation), a user may provide his or her physical location to a computer using speech recognition, as described below. Upon speaking the user's location, the system translates the voice information to location data at time T5, and can send the user-provided location to the LBS. For instance, where an LBS is a friend finder service, the LBS may use the location information to locate any of the user's friends that are nearby. Other data services may easily be envisioned that use data provided by voice.

After generating the data, the voice channel is terminated at time T6, and the data channel is reactivated at time T7. The data generated at time T5 is sent to the data service at time T8. The data service may then continue providing data services at time T9, incorporating the information received. At some time after T9, the data channel is terminated at time T10 when the user has completed using the data service.

In some embodiments, the first data channel opened at time T1 may be terminated at time T3, and a second data channel may be opened at time T7. The data generated at time T5 may then be passed as input to the new data channel opened at time T7.

In a preferred embodiment, voice-geocode technology is used to identify a location of a mobile unit. The location determination engine may be automated, utilizing voice-recognition and text-to-speech technologies. Using a hierarchical database, the voice-geocode system can quickly and efficiently provide a geographical coordinate corresponding to the spoken location. The system may identify a location using a street address or an intersection of two streets. The voice-geocode architecture is universal and scalable. That is, the same architecture may be used for any geographic area, and for any number of MUs. The voice-geocode system may be implemented using the Java programming language in an Enterprise Java Beans (EJB) architecture. Integrated EJB components within the voice-geocode application server provide location services to external applications. Other programming languages may be used, for instance, PERL, C, Visual Basic, and the like.

With reference to the data flow diagram shown in FIG. 2B, a mobile locating center (MLC) 171 may provide location information of one or more MUs 177a-177d to other applications and/or data services 179. That is, upon request by a data service 179, the MLC provides the location of a MU, using any means available (e.g., GPS, TDOA, voice-geocode, etc.) for the requested MU. The MLC may receive GPS information from some MUs (e.g., MU 177a), or the MLC may receive location information from a TDOA system 173 or an AOA system 175. If a non-voice geocode system is available, or if the user wants to enter a location other than his or her present location, the MLC may receive the location information from a voice geocode module 174.

Using the embodiment shown in FIG. 2B, a single telecommunications system can accommodate MUs with different capabilities. That is, a telecommunications system can perform location services for MUs with and without GPS capabilities. Also, the same telecommunications system can perform location services for MUs located in areas with and without network-based location determination technologies, such as TDOA, AOA, and the like. In addition, the same telecommunications system can accommodate MUs without GPS and located in an area without network-based location determination capability, all transparent to the location-based application.

As shown in FIG. 2C, the MLC is configured with logic to determine the location of the MU based on the technology with which the specific MU and/or the MLC is enabled. The MLC initially receives a request for a MU location in step 181. If the MLC has previously received the MU's location within a predetermined amount of time, as determined in step 183, the MLC proceeds to output the location in step 197. Otherwise, the MLC queries in step 185 whether the MU is GPS enabled. If the MU is GPS-enabled, the MLC gets the MU's GPS location information in step 187. If the MU is not GPS-enabled, the MLC queries in step 189 whether a network-based location determination method is available. If a network-based location system is available, the MLC gets the MU's location information from the network-based location system in step 191. If no network-based location system is available, the MLC initiates a voice channel with the MU in step 193, and proceeds to perform steps 201-231, as described below. Upon completion of steps 201-231, the MLC outputs the MU location in step 197.

The voice-geocoder module generally takes one argument, a MU's phone number, and returns a LAT/LON coordinate. Inside the voice-geocoder, voice-recognition and text-to-speech technologies are used to interrogate the user of the MU, determine the state, city, street, and address number or cross street. When the cross street or street number is offered, the voice-geocoder invokes another component, referred to herein as the geocoder, to determine if the proposed address is a valid location. The voice-geocoder converts a user's spoken location into text location information. The geocoder receives the text and converts the location into latitude and longitude coordinates by comparing the text location information to a database of possible locations, further described below. If the proposed address is not a valid location the user is prompted to re-enter the specific address, number or cross street so as to determine the proper coordinate.

Voice recognition software that may be used in the invention is Nuance, commercially available from Nuance Communications, located in Menlo Park, Calif. Text-to-speech software which may be used in the invention is FAAST TTS, commercially available from Fonix Corporation, located in Salt Lake City, Utah.

The voice-geocoder may operate using a drill-down hierarchy scheme. A system embodying the invention prompts a user for a high level description his or her location, e.g., the user's state. The system successively prompts the user for his or her location with more precision, e.g., city, street, etc. At each level, the voice recognition software compares the user's response to a grammar file containing information corresponding to the domain of allowable responses at that level. Hierarchies of different levels are possible, depending on the domain of possible locations.

In one embodiment of the invention, the area of possible locations is defined as the U.S. In such an embodiment, a four-level hierarchy may be used. At a first level, a user is prompted to enter (speak) his or her state. At a second level, the user is prompted to enter his or her city. At a third level, the user is prompted to enter his or her street. At a fourth level, the user is prompted to enter either his or her cross-street (if he or she is at an intersection) or the address on the street on which he or she is located (if he or she is on a block of the street). Based on the four pieces of information, a precise location may be determined for the user. In some embodiments, more or fewer levels in the hierarchy are used. For instance, a fifth level (“Country”) could easily be added to the top of the hierarchy to enable the system for global locations.

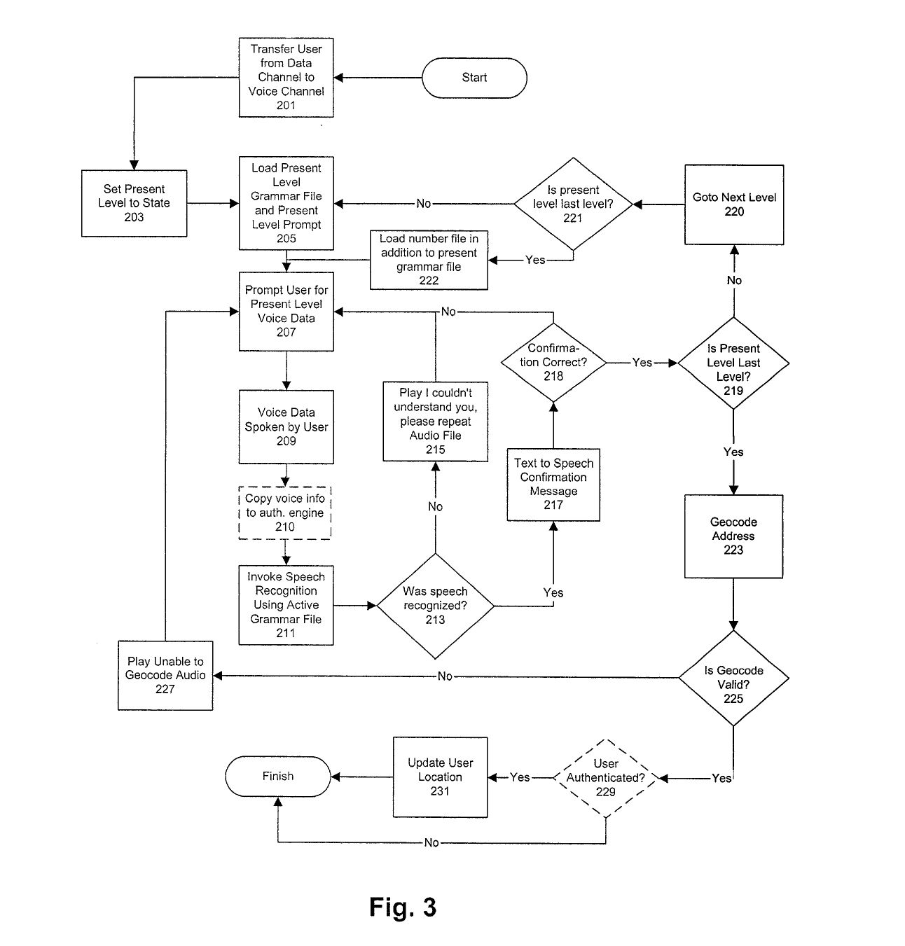

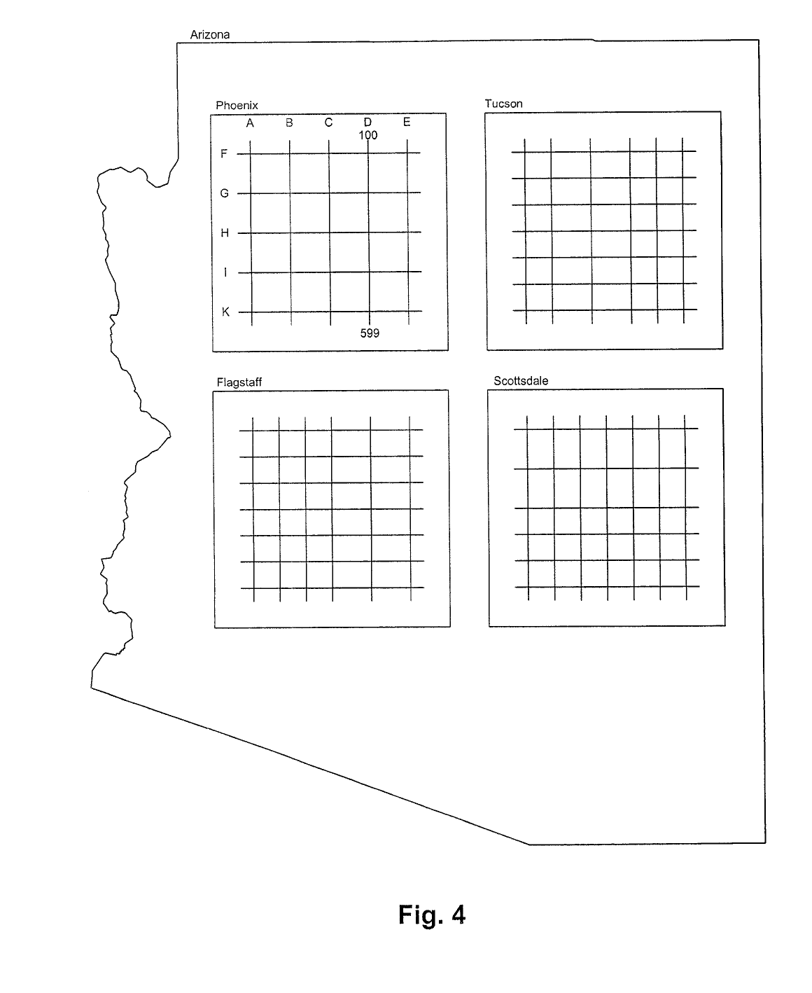

An embodiment of the invention will now be described with reference to FIGS. 3 and 4, ignoring optional steps 210 and 229. A data application, upon determining that an MU's location is needed, in step 201 transfers the MU from the data channel to a voice channel so that the user may provide his or her location using the inventive geocode process. In step 203, the present geographic level is set to the first level of the hierarchy, which in this instance is a location's State. That is, the system will use a grammar file that only contains information corresponding to the states in the U.S. The appropriate grammar file is loaded in step 205, as is a corresponding audible prompt for playback to the user. The audible prompt may be a prerecorded voice prompt or the like, such that when played back to the user, the user has an understanding of the information the user should then provide.

In step 207 the user is presented with the audible prompt to enter (speak) information. The user hears the audible prompt to enter (speak) the state in which he or she is located because the present level is set to State. The user's response is received and recorded in step 209. In step 211, the voice recognition software compares the user's response to the active grammar file (in this first instance, the State grammar file). The system makes a determination of whether the user's response matches an entry in the grammar file in step 213. If the user's response did not match an entry in the grammar file, the user is played an error message in step 215, and returned to step 207.

If the user's response was recognized in step 213, the system plays back an audible confirmation to the user, in step 217. The audible confirmation is an audio playback of what the system understood the user's response to be. This recording may be a speech synthesized audible message of the interpreted response. For instance, if the user speaks the phonetic sounds “âr-\check{u}-zo-n\check{u}” in step 209, based on the user's speech the system may interpret the user's response to be the state of Arizona. The system looks up text corresponding to the user's response, such as “Arizona” or “State: Arizona,” and processes the text using text-to-speech software for audible playback to the user.

In step 218 the user is prompted whether the confirmation was correct. This is because even though the speech was recognized within the grammar file, the speech may have been interpreted incorrectly. For instance, a user might have spoken the word “Arizona,” while the system interpreted the response to be “Alabama” (due to the repeated ‘a’ sounds). The user can detect that the response was incorrectly interpreted and notify the system of such in step 218. If the response was incorrectly interpreted, the system goes back to step 207 for re-entry.

If the response was correctly interpreted, the system proceeds to step 219, where a determination is made of whether the present level is the last level. That is, in a system with four levels (State, City, Street, Cross-street or Address), the system must proceed through four levels of input. Because only the first level has been completed, the system will proceed to the next level in step 220. In step 220, the system advances the present level by one (e.g., state to city, city to street, street to cross-street/address), and proceeds to check whether the newly set level is the last level in step 221. If the newly loaded level is not the last level, then the system returns back to step 205. In the present example, the system will load the grammar file for cities in Arizona, such as Phoenix, Tucson, Flagstaff, Scottsdale, and the like.

After completing the above iterations for the Street level, the system will advance to the last level, Address/Cross-street, in step 220, and determine that the present level is the last level in step 221. Upon making this determination, instead of proceeding to step 205, the system proceeds to step 222 where it loads an address grammar file in addition to the already loaded Street grammar file. The Address grammar file is a grammar file containing information corresponding to the range of possible street addresses that the user may speak. That is, the Address file is not limited to the range of possible addresses for the recently selected street, but rather it contains all possible numbers which may be provided as addresses. Thus, at this last level, the user may speak any street in the city or any address, not just cross streets or addresses within the range known to be on the selected street. This reduces the amount of individual grammar files that must be maintained.

In the present example, after the user selects the city Phoenix, the system will load a grammar file containing the streets located at least partially within the city of Phoenix, including A, B, C, D, E, F, G, H, I, and K streets as shown in FIG. 4. If the user next selects D street, the system will leave the street grammar file in memory, and also load an address number grammar file containing the range of possible addresses, for instance the numbers 1-99,999. Other address sets are possible, such as different number ranges, letters for apartments or suites, half-step addresses such as 712 ½, and the like. The user may then select a cross street or an address within the two loaded grammar files.

After completing the above iterations for State, City, Street, and Cross-Street/Address, the system will determine, in step 219, that the present level is the last level. Upon such an occurrence, the system will proceed to step 223 for geocoding.

Geocoding in step 223 includes accepting as input the user responses from each level of the hierarchy, and attempting to translate the state, city, street, and cross-street or address into a second form of location identifying data. Geocoding in this step may not always be successful. For instance, in the present example, if the user entered, at the last level, any of A, B, C, D, or E streets, or any address outside the range 100-599 D Street, the geocode will be returned as invalid. It is during the geocoding process that the system checks the validity of the address or cross-street, and if valid, translates the user provided information into location identifying data.

The location identifying data may be coordinates of latitude and longitude with varying degrees of specificity. That is, depending on the accuracy of the system or the identified location, the location identifying data may be provided in degrees, degrees and minutes, or even degrees, minutes, and seconds.

The system determines, in step 225, If the geocode of step 223 is not valid. That is, the geocode may not be valid if the user provides, at the last response level, a cross-street that does not intersect the selected street. The geocode also may not be valid if the user provides, at the last level, an address that does not exist on the selected street. If the geocode is not valid, the system notifies the user, in step 227, that the system is unable to geocode the user's audible responses, and returns to step 207. In step 207, the user is prompted to reenter a cross-street or address. If the geocode was completed and is valid, the system updates the user's location in step 231. The data service previously being used before the voice-geocode process was started may then be resumed by the system and/or the user.

In one aspect of the invention, a grammar file specific to the selected street is loaded at the last level, thus negating the need for steps 221, 222, and 225. However, there is a tradeoff in that system performance may be reduced depending on the processing power of the data processing system being used to perform the database and grammar file manipulation. This is because the number of grammar files required to accommodate each street in each city in each state is quite large.

Data for each grammar file may be created using a database of valid street addresses, such as the U.S. Census Bureau's Topologically Integrated Geographic Encoding and Referencing (TIGER) database. A program may be used to parse the database and create location specific grammar files, i.e., grammar files for possible responses at each level of the hierarchy, depending on the previous response when not at the top level.

It is possible that there are multiple matches within the grammar file. For instance, within a city, there may be a Main St. and a Main Ave. In such a case (not shown), the system may prompt the user for clarification, using either audible responses or touch tone responses by the user.

In some embodiments a location may be determined based on the name of a landmark. The system may recognize a trigger response at any level, which would allow the user to simply speak the name of a landmark. For instance, if the user speaks the word “landmark,” the system may be adapted to load a specific grammar file containing landmarks at the present hierarchical level instead of the default grammar file. That is, if after speaking the state “California” and the city “San Francisco,” the system will load the grammar file corresponding to streets in San Francisco. However, if the user speaks the word “landmark” (or some other trigger word) the system may load a grammar file corresponding to landmarks in and around San Francisco, Calif. If the user then speaks “Golden Gate Bridge” the system may automatically proceed to geocoding based on the location of the spoken landmark, regardless of whether the user proceeded through every level of the hierarchy. The trigger word may be spoken at any level. Generally, the higher the level, the more well known the landmark should be to be included in the grammar file for that level. However, this is not necessarily the case, and is limited only by system processing speed and capacity. Optionally, a trigger word is not required, and landmarks may be included within each grammar file.

Using the present invention, because the location information is provided by voice, a user is not required to enter his or her present location, but rather may speak any location. For instance, if a user is using a location-based service via his or her MU to receive travel information, the user may enter the location of the travel destination before the user gets there, thus enabling the user to receive information in advance of the anticipated travel. A user may use this information to find the location of hotel proximate to his/her final travel destination, in order to make hotel reservations. The present invention may also be used by phones equipped with GPS capability when the user desires to enter a location other than the MU's current location.

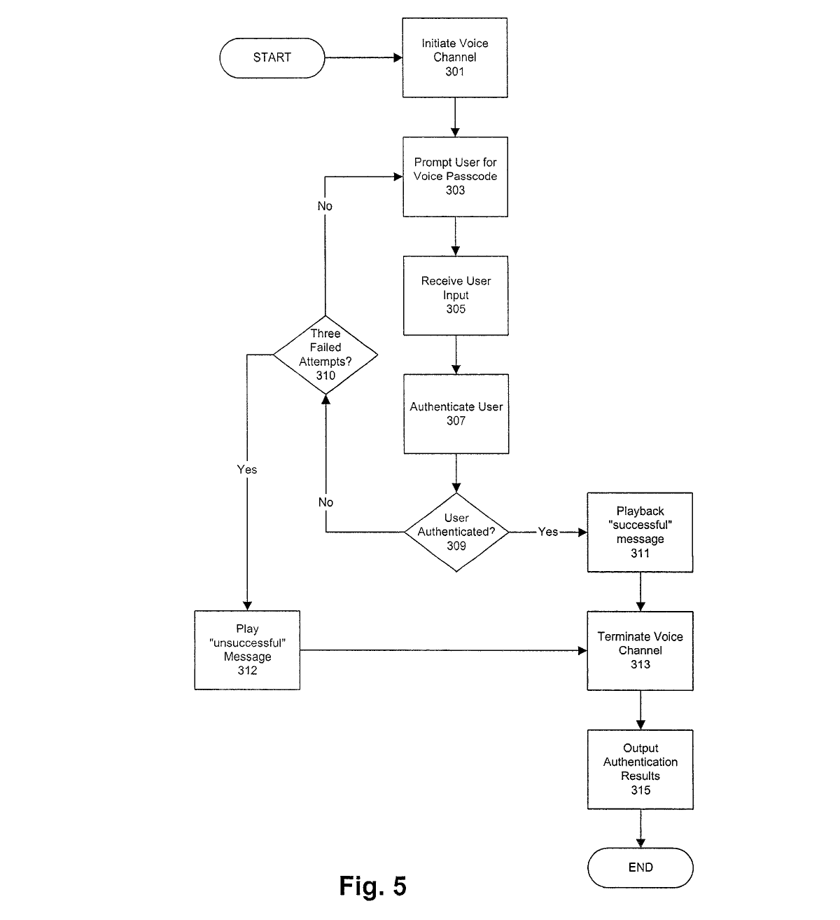

In another embodiment of the invention, with reference to FIG. 5, voice information may be used to authenticate a user before providing a predetermined service. Software for voice authentication that may be used is Nuance Verifier, commercially available from Nuance Communications in Menlo Park, Calif. To perform voice authentication, a voice passcode is used. That is, in a trusted environment where the user's identity is not questioned, the system prompts a user for a spoken word or phrase that is to be used as the passcode. The system stores this authentication information in a database. Thereafter, to authenticate the user, not only must the correct passcode be spoken, but the same user must speak it. These authentication procedures are performed within the voice authentication software.

When a data service determines that user authentication must be performed, a voice channel is initiated in step 301. The system plays an audio prompt over the voice channel, requesting that the user speak his or her passcode in step 303. The user responds by speaking into the mobile unit in step 305. The system, in step 307, compares the user's spoken response to the user's authentication information to determine whether the speaker is actually who he or she claims to be. The system determines whether the user is authenticated in step 309, i.e., the speaker's response matches the passcode and the speaker's voice is the same voice used to create the passcode.

If the user is not authenticated, the system checks to determine whether the user has three failed attempts in step 310. Other numbers of attempts may be used. If the user has not yet attempted voice authentication three times, the system returns to step 303 and again prompts the user to speak his or her passcode. If the user has unsuccessfully attempted voice authentication three times, the system proceeds to step 312 where the user is informed that voice authentication was unsuccessful. The system then proceeds to step 313. If the user is authenticated in step 309, the system proceeds to step 311 and plays back a message through the mobile unit, informing the user that voice authentication was successful. Steps 311 and 312 are optional. In step 313 the system terminates the voice channel. The system sends the authentication results to the data service in step 315.

In another embodiment of the invention (not shown), the voice authentication is performed based on the user's voice, and not on a passcode. That is, the system may analyze the user's voice to determine whether the user is who they claim to be, based on the predetermined authentication information for an individual.

In an embodiment of the invention, shown in FIG. 3 including optional steps 210 and 229, only an authenticated user of a mobile unit may update the MU's location using the voice-geocode process. After each iteration of step 209, the system (in step 210) copies the user's spoken response to a voice authentication engine. The voice authentication engine used in this embodiment does not require a user passcode for voice authentication, but rather authenticates a user based on the user's voice.

While the voice-geocode process is operating, the voice authentication engine analyzes the user's spoken responses from step 209 against predetermined authentication information for an individual, such as the owner of record of the MU, in order to determine whether the user is authorized to update the MU's location. After the voice-geocoder has obtained a valid geocode in step 225, the system checks to determine whether the user was authenticated in step 229. If the user was authenticated by the voice authentication engine, the system updates the MU location in step 231. However, if the user was not authenticated, the MU location is not updated. Optionally (not shown), the user may receive an indication that the location will not be updated because the user could not be authenticated.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

What is claimed is:

1. A method for obtaining data in a mobile telecommunications network comprising a plurality of mobile units and a plurality of base units, the method comprising the steps of:
(1) initiating an application using a data channel;
(2) receiving audible input spoken by a user over a voice channel;
(3) converting the audible input to application data;
(4) providing the application data to the application.

2. The method of claim 1, wherein the application data comprises location information.

3. The method of claim 2, wherein the location information comprises latitude and longitude information.

4. The method of claim 2, wherein step (3) comprises the steps of:
(a) loading a first data file corresponding to a first set of localities;
(b) comparing a first audible input to the first data file to determine a first selected locality; and
(c) loading a second data file corresponding to a second set of localities, wherein each of the localities in the second set are geographically located within the selected locality.

5. The method of claim 4, wherein step (3) further comprising the steps of:
(d) repeating steps (b)-(c) while a physical location is not yet identified within a predetermined degree of precision; and
(e) determining the location information based on the selected localities.

6. The method of claim 4, wherein step (3) further comprising the steps of:
(d) repeating steps (b)-(c) a predetermined number of times;
(e) loading a last data file in addition to the presently loaded data file;
(f) comparing a last audible input to the loaded data files to determine a last selected locality; and
(g) determining the location information based on the selected localities.

7. The method of claim 4, wherein at least one of the sets of localities includes a landmark, and said method further comprising the step of:
(d) when the selected locality is a landmark, determining location information corresponding to the selected landmark.

8. The method of claim 1, wherein the application data comprises authentication information.

9. The method of claim 8, wherein step (3) comprises the steps of:
(a) comparing the audible input to preexisting voice information corresponding to a predetermined person; and
(b) determining authentication information corresponding to whether the user is the predetermined person.

10. A method of refining a location using a voice channel in a telecommunications network, the method comprising the steps of:
(a) loading a first data file corresponding to a first set of localities;
(b) comparing a first audible input to the first data file to determine a first selected locality; and
(c) loading a second data file corresponding to a second set of localities, wherein each of the localities in the second set are geographically located within the selected locality.

11. The method of claim 10, further comprising the steps of:
(d) repeating steps (b)-(d) while a physical location is not yet identified within a predetermined degree of precision; and
(e) determining location information based on the selected localities.

12. The method of claim 10, further comprising the steps of:
(d) repeating steps (b)-(d) a predetermined number of times; and
(e) determining location information based on the selected localities.

13. The method of claim 10, wherein at least one of the sets of localities includes a landmark, and further comprising the step of:
(d) when the selected locality is the landmark, determining location information corresponding to the selected landmark.

14. The method of claim 10, further comprising the steps of:
(d) repeating steps (b)-(c) a predetermined number of times;
(e) loading a last data file in addition to the presently loaded data file;
(f) comparing a last audible input to the loaded data files to determine a last selected locality; and
(g) determining location information based on the selected localities.

15. A system for providing voice channel services in a wireless telecommunications network comprising:
a processor;
a memory for storing computer readable instructions, such that when executed, the system performs the steps of:
(1) initiating an application using a data channel;
(2) receiving audible input spoken by a user over a voice channel;
(3) converting the audible input to application data; and
(4) providing the application data to the application.

16. The system of claim 15, wherein the application data comprises location information.

17. The system of claim 16, wherein the location information comprises latitude and longitude information.

18. The system of claim 16, wherein step (3) comprises the steps of:
(a) loading a first data file corresponding to a first set of localities;
(b) comparing a first audible input to the first data file to determine a first selected locality; and
(c) loading a second data file corresponding to a second set of localities, wherein each of the localities in the second set are geographically located within the selected locality.

19. The system of claim 18, wherein step (3) further comprises the steps of:
(d) repeating steps (b)-(c) while a physical location is not yet identified within a predetermined degree of precision; and
(e) determining the location information based on the selected localities.

20. The system of claim 18, wherein step (3) further comprises the steps of:
(d) repeating steps (b)-(c) a predetermined number of times; and
(e) determining the location information based on the selected localities.

21. The system of claim 18, wherein step (3) further comprises the steps of:
(d) repeating steps (b)-(c) a predetermined number of times;
(e) loading a last data file in addition to the presently loaded data file;
(f) comparing a last audible input to the loaded data files to determine a last selected locality; and
(g) determining location information based on the selected localities.

22. The system of claim 18, wherein at least one of the sets of localities includes a landmark, and further comprising the step:
(d) when the selected locality is the landmark, determining location information corresponding to the selected landmark.

23. The system of claim 15, wherein the application data comprises authentication information.

24. The system of claim 23, wherein step (3) comprises the steps of:
(a) comparing the audible input to preexisting voice information corresponding to a predetermined person; and
(b) generating authentication information corresponding to the comparing performed in step (a); and
(c) outputting the authentication information.

25. A system for refining a location using a voice channel over a mobile unit, comprising:
a processor;
a memory for storing computer readable instructions, such that when executed, the system performs the steps of:
(a) loading a first data file corresponding to a first set of localities;
(b) comparing a first audible input to the first data file to determine a first selected locality; and
(c) loading a second data file corresponding to a second set of localities, wherein each of the localities in the second set are geographically located within the selected locality.

26. The system of claim 25, wherein the system further performs the steps of:
(d) repeating steps (b)-(c) while a physical location is not yet identified within a predetermined degree of precision; and
(e) determining location information based on the selected localities.

27. The system of claim 25, wherein the system further performs the steps of:
(d) repeating steps (b)-(c) a predetermined number of times; and
(e) determining location information based on the selected localities.

28. The system of claim 25, wherein the system further performs the steps of:
(d) repeating steps (b)-(c) a predetermined number of times;
(e) loading a last data file in addition to the presently loaded data file;
(f) comparing a last audible input to the loaded data files to determine a last selected locality; and
(g) determining location information based on the selected localities.

29. The system of claim 25, wherein at least one of the sets of localities includes a landmark, and wherein the system further performs the step of:
(d) when the selected locality is the landmark, determining location information corresponding to the selected landmark.

30. A method of locating a mobile unit (MU), comprising the steps of:
(1) determining whether an automated location determination system exists in a telecommunications network;
(2) when the result from step (1) is positive, receiving location information generated in the telecommunications network; and
(3) when the result from step (1) is negative, prompting a user to audibly provide location information.

31. The method of claim 30, wherein the automated location determination system is a global positioning system.

32. The method of claim 30, wherein the automated location determination system is a network based system.

33. The method of claim 32, wherein the network based system is one of the group of a time difference of arrival (TDOA) system and an angle of arrival (AOA) system.

34. A mobile unit locating system comprising:
a database of mobile unit locations;
an interface to communicate with a mobile unit enabled with a global positioning system;
an interface to communicate with a network based location determining system; and
an interface to communicate with a voice-based location determining system;
wherein the global positioning system, network based location determining system, and the voice-based location determining system provide location information stored in the database.

35. The system of claim 34, wherein the network based location determining system is one of a time difference of arrival (TDOA) system and an angle of arrival (AOA) system.

36. The method of claim 5, wherein step (3) further comprising the steps of:
(f) authenticating a user based on the audible inputs;
(g) outputting the location information only when the user was successfully authenticated in step (f).

37. The method of claim 6, wherein step (3) further comprising the steps of:
(f) authenticating a user based on the audible inputs;
(g) outputting the location information only when the user was successfully authenticated in step (f).

38. The method of claim 7, wherein step (3) further comprising the steps of:
(f) authenticating a user based on the audible inputs;
(g) outputting the location information only when the user was successfully authenticated in step (f).

39. The method of claim 11, further comprising the steps of:
(f) authenticating a user based on the audible inputs;
(g) outputting the location information only when the user was successfully authenticated in step (f).

40. The method of claim 12, further comprising the steps of:
(f) authenticating a user based on the audible inputs;
(g) outputting the location information only when the user was successfully authenticated in step (f).

41. The method of claim 13, further comprising the steps of:
(f) authenticating a user based on the audible inputs;
(g) outputting the location information only when the user was successfully authenticated in step (f).

42. The method of claim 14, further comprising the steps of:
(f) authenticating a user based on the audible inputs;
(g) outputting the location information only when the user was successfully authenticated in step (f).

43. The system of claim 19, wherein step (3) further comprises the steps of:
(f) authenticating a user based on the audible inputs;
(g) outputting the location information only when the user was successfully authenticated in step (f).

44. The system of claim 20, wherein step (3) further comprises the steps of:
(f) authenticating a user based on the audible inputs;
(g) outputting the location information only when the user was successfully authenticated in step (f).

45. The system of claim 21, wherein step (3) further comprises the steps of:
(f) authenticating a user based on the audible inputs;
(g) outputting the location information only when the user was successfully authenticated in step (f).

46. The system of claim 22, wherein step (3) further comprises the steps of:
(f) authenticating a user based on the audible inputs;
(g) outputting the location information only when the user was successfully authenticated in step (f).

47. The system of claim 26, wherein the system further performs the steps of:
(f) authenticating a user based on the audible inputs;
(g) outputting the location information only when the user was successfully authenticated in step (f)

48. The system of claim 27, wherein the system further performs the steps of:
(f) authenticating a user based on the audible inputs;
(g) outputting the location information only when the user was successfully authenticated in step (f).

49. The system of claim 28, wherein the system further performs the steps of:
(f) authenticating a user based on the audible inputs;
(g) outputting the location information only when the user was successfully authenticated in step (f).

50. The system of claim 29, wherein the system further performs the steps of:
(f) authenticating a user based on the audible inputs;
(g) outputting the location information only when the user was successfully authenticated in step (f).

51. A method of determining a location, comprising the steps of:
(1) loading a first data file comprising state information;
(2) receiving a first audible input from a user;
(3) comparing the first audible input to the first data file to determine a selected state;
(4) loading a second data file comprising a plurality of cities, wherein each city is geographically located at least partially in the selected state;

52. The method of claim 51, further comprising the steps:
(5) receiving a second audible input from the user;
(6) comparing the second audible input to the second data file to determine a selected city;
(7) loading a third data file comprising a plurality of streets, wherein each street is geographically located at least partially in the selected city;

53. The method of claim 52, further comprising the steps:
(8) receiving a third audible input from the user;
(9) comparing the third audible input to the third data file to determine a selected street;
(10) loading a fourth data file comprising a range of addresses;

54. The method of claim 53, further comprising the steps:
(11) receiving a fourth audible input from the user;
(12) comparing the fourth audible input to the third and fourth data files to determine one of a selected cross-street and a selected address;
(13) determining whether the selection from step (12) is a valid selection;
(14) generating location coordinates from the selected state, city, street, and cross-street or address.

55. A system for refining a location using a voice channel over a mobile unit, comprising:
a processor;
a memory for storing computer readable instructions, such that when executed, the system performs the steps of:
(1) loading a first data file comprising state information;
(2) receiving a first audible input from a user;
(3) comparing the first audible input to the first data file to determine a selected state;
(4) loading a second data file comprising a plurality of cities, wherein each city is geographically located at least partially in the selected state;

56. The system of claim 55, wherein the system further performs the steps:
(5) receiving a second audible input from the user;
(6) comparing the second audible input to the second data file to determine a selected city;
(7) loading a third data file comprising a plurality of streets, wherein each street is geographically located at least partially in the selected city;

57. The system of claim 56, wherein the system further performs the steps:
(8) receiving a third audible input from the user;
(9) comparing the third audible input to the third data file to determine a selected street;
(10) loading a fourth data file comprising a range of addresses;

58. The system of claim 57, wherein the system further performs the steps:
(11) receiving a fourth audible input from the user;
(12) comparing the fourth audible input to the third and fourth data files to determine one of a selected cross-street and a selected address;
(13) determining whether the selection from step (12) is a valid selection;
(14) generating location coordinates from the selected state, city, street, and cross-street or address.
